(19) United States
(12) Patent Application Publication
(10) Pub. No.: US 2014/0043300 A1
(43) Pub. Date: Feb. 13, 2014

(54) ELECTROMAGNETIC POINTER

(71) Applicant: Chien-Chia LIEN, HSIN-CHU CITY (TW)

(72) Inventor: Chien-Chia LIEN, HSIN-CHU CITY (TW)

(21) Appl. No.: 13/608,046

(22) Filed: Sep. 10, 2012

(30) Foreign Application Priority Data
Aug. 7, 2012 (TW) 101215173

(51) Int. Cl. G06F 3/033

(52) U.S. Cl. 345/179; 178/19.01

(57) ABSTRACT

An electromagnetic pointer comprising a pen tip, a first and second ferrite cores, a coil surrounding the first ferrite core, a core holder, a circuit board holder and a circuit board is disclosed. The pen tip penetrates through the first ferrite core. The surface of one end of the core holder has a first thread thereon. An elastomer and a touch pin are configured in the core holder. The touch pin extends out from the end with the first thread of the core holder. The inner surface of one end of the circuit board holder has a second thread so that the core holder is able to be screwed into the circuit board holder. The circuit board has a plurality of conductive terminals on one end thereof. The conductive terminals are configured adjacent the touch pin. A conductive device is between the conductive terminals and the touch pin.

### FIELD OF THE INVENTION

The present invention generally relates to an electromagnetic pointer, more particularly to an electromagnetic pointer with an adjustable structure.

### BACKGROUND OF THE INVENTION

Input apparatuses or electronic appliances such as smart mobile devices (Smart Phone), digitizers or tablets or e-books/green books include a plurality of antennas or sensor coils forming a sensing plane arranged under a work surface of the digitizer tablet or a screen of the e-book, and a pointer for a user to operate the input apparatuses or electronic appliances. The coordinates of the pointer are obtained through the transmitting and receiving of electromagnetic waves between the circuit of the pointer and the antennas or the sensor coils.

The circuit of the pointer including electromagnetic pens or styluses usually comprises an inductor, a capacitor and relative components enclosed in a case. The inductor constituted by a ferrite core winded with a metal coil and the capacitor constitute the circuit to transmit and receive electromagnetic waves with the antennas or sensor coils. The frequency variation of the circuit is achieved via changing the capacitance and the inductance so that the design of the pointer can choose either the inductor or capacitor to be variable or adjustable according to the requirement.

Through the variation of contact force of the tip of an electromagnetic pen or a stylus applied upon a digitizer or tablet, the pen core is displaced to moved the ferrite core inside the metal coil as well as related components and to press and deform an elastic material such as rubber to change the inductance, capacitance and frequency of electromagnetic signals.

U.S. Pat. No. 5,565,632 discloses that the inductance and frequency of the electromagnetic pen are changed through the relative displacement of a small ferrite core ahead a large ferrite core with a winding coil. The disadvantage of the electromagnetic pen includes incline angle distortion and coordinate fluctuation of the electromagnetic pen. The problem of incline angle distortion results from the variation of the distribution of magnetic lines when the small ferrite core moves ahead the winding coil. The problem of coordinate fluctuation is induced by the variation of the amplitudes of electromagnetic signals when the small ferrite core moves ahead the winding coil. Moreover, the illustrated design lacks an adjustable structure to adjust possible frequency deviation.

U.S. Pat. No. 6,853,369 B2 shows an electromagnetic pen design with a sensitive variable capacitor which is able to be changed via the variation of the force of the pen core applied, and the frequency is changed according to the capacitance of the variable capacitor. The disadvantage of the electromagnetic pen includes inaccurate frequency induced by unavoidable manufacturing tolerances of dimensions (length or height) and lack of a remedial design of adjustable structure.

In view of the problems of manufacturing techniques and design of the conventional pointer devices, the invention provides an electromagnetic pointer to solve these issues.

### BRIEF SUMMARY OF THE INVENTION

One object of the invention is to provide an electromagnetic pointer which can adjust the possible gaps between the components inside the electromagnetic pointer due to tolerances of dimensions or assembling to eliminate unnecessary error. The force needed to perform the writing function applied upon the electromagnetic pointer is able to be set by adjusting the degree of screwing tightness of the core holder.

The invention provides an electromagnetic pointer comprising a pen tip, a first ferrite core, a second ferrite core, a coil surrounding the first ferrite core, a core holder, a circuit board holder and a circuit board. The pen tip penetrates through the first ferrite core. The surface of one end of the core holder has a first thread thereon. An elastomer and a touch pin are configured in the core holder. The touch pin extends out from the end with the first thread of the core holder. The inner surface of one end of the circuit board holder has a second thread so that the core holder is able to be screwed into the circuit board holder. The circuit board has a plurality of conductive terminals on one end thereof. The conductive terminals are configured adjacent the touch pin. A conductive device is configured between the conductive terminals and the touch pin. The coil connects to the circuit board.

### BRIEF DESCRIPTION OF THE DRAWINGS

FIG. 1A and FIG. 1B show top and side view respectively of an electromagnetic pointer according one embodiment of the present invention.

FIG. 2 is a cross-sectional view of an electromagnetic pointer according one embodiment of the present invention.

FIG. 3 is an exploded view of an electromagnetic pointer according one embodiment of the present invention.

### DETAILED DESCRIPTION OF THE INVENTION

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well known process operations are not described in detail in order not to unnecessarily obscure the present invention.

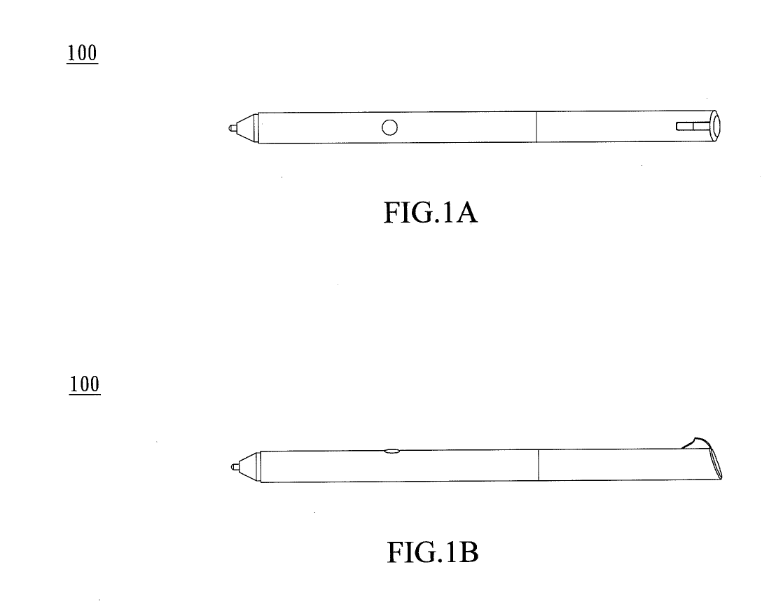

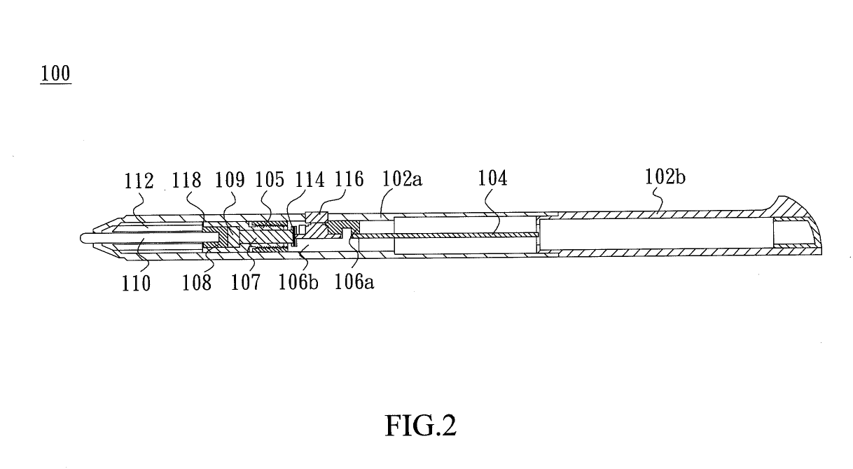

FIG. 1A and FIG. 1B show top and side view respectively of an electromagnetic pointer according one embodiment of the present invention. FIG. 2 is a cross-sectional view of an electromagnetic pointer according one embodiment of the present invention. As shown in FIG. 2, the electromagnetic pointer device 100 of the invention comprises pen cases 102a and 102b, a circuit board 104, a core holder 105, holders 106a and 106b, a touch pin 107, an elastomer 109, a pen core 110, ferrite cores 108 and 112, a conductor device 114, a switch 116 and a buffer 118.

The pen cases 102a and 102b comprise hollow pen shell components made of non-metal materials to accommodate the circuit board 104, the core holder 105, the holders 106a and 106b, the touch pin 107, the elastomer 109, the ferrite cores 108 and 112 and the pen core 110. The diameters of the pen cases 102a and 102b are about 7.2 mm, but is not limited to 7.2 mm.

In one embodiment of the invention, the ferrite core 112 is hollow. The pen core 110 penetrates through the ferrite core 112 so that the pen core 110 is able to slide through the ferrite core 112. The ferrite core 108 includes a groove or a trench or a concave to accommodate one end of the pen core 110. One end of the ferrite core 112, one end of the pen core 110, the ferrite core 108, the elastomer 109, and the touch pin 107 are configured to be adapted inside the core holder 105. The ferrite core 112, the pen core 110, the portion of the ferrite core 108 inside the ferrite core 105, the elastomer 109, and the touch pin 107 are configured to be adapted inside the hollow pen case 102a.

The hollow core holder 105 is configured to be located in the pen case 102a. In addition to accommodate one end of the ferrite core 112, one end of the pen core 110, the ferrite core 108, the elastomer 109, and the touch pin 107, the surface of one end of the core holder 105 has a thread configured to join with a thread inside the holder 106b so that the core holder 105 is able to be screwed in to one end of the holder 106b.

The core holder 105 and the holder 106b are joined to secure the ferrite core 112, and the pen core 110 is able to be moved axially inside the ferrite core 112. When the pen core 110 is moved axially inside the ferrite core 112, the end of the pen core 110 configured in the groove of the ferrite core 108 pushes the ferrite core 108 to generate a relative displacement between the ferrite core 108 and the ferrite core 112 with the winding coil. Detail content will be further described in the following description. The elastomer 109 and the touch pin 107 are configured to be located inside the core holder 105. The elastomer 109 is located between the ferrite core 108 and the touch pin 107. When the ferrite core 108 is pushed by the pen core 110 to generate a relative displacement between the ferrite core 108 and the ferrite core 112 with the winding coil, the elastomer 109 will be compressed and push the touch pin 107. The touch pin 107 is able to slide inside the core holder 105, while one end of the touch pin 107 extends out from the end of the core holder 105 with the thread.

In one embodiment of the invention, the circuit board 104 is configured to be secured in the pen cases 102a and 102b via the holder 106a and 106b. The end of the circuit board 104 toward the tip of the electromagnetic pointer has a plurality of conductive terminals. The conductive device 114 is configured to be located between the circuit board 104 and the touch pin 107. The conductive terminals of the circuit board 104 are electrically connected through the conductive device 114 after the touch pin 107 pushes the conductive device. Detail content will be further described in the following description. The switch 116 is configured to be located on the circuit board 104 and extend out from the pen case 102a. The switch 116 is used as a switch of the circuit board 104.

In one embodiment of the invention, the circuit board 104 comprises a printed circuit board with a LC circuit and a controller so that the electromagnetic pointer is able to transmit electromagnetic signals to an electromagnetic input apparatus, or to receive electromagnetic signals from electromagnetic antenna loops or sensor coils of the electromagnetic input apparatus. The electromagnetic input apparatus comprises a smart mobile communication devices, digitizer or tablet or eBook.

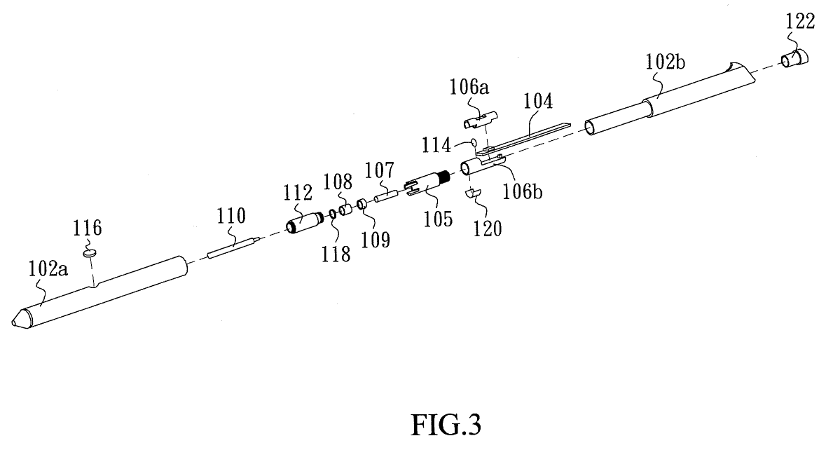

FIG. 3 is an exploded view of an electromagnetic pointer according one embodiment of the present invention. Referring to both FIG. 2 and FIG. 3 is beneficial to further understand the electromagnetic pointer according one embodiment of the present invention. As shown in FIG. 3, the pen core 110 penetrates through the ferrite core 112 so that the pen core 110 is able to slide through the ferrite core 112. The ferrite core 108 accommodates one end of the pen core 110 and is configured to be located after the ferrite core 112. The buffer 118 is configured to be located between the ferrite cores 108 and 112. The buffer 118 comprises a material of Mylar. The elastomer 109 and the touch pin 107 are configured to be sequentially located after the ferrite core 108 in the core holder 105. The elastomer 109 is configured to be located between the ferrite core 108 and the touch pin 107. The touch pin 107 is configured to be able to be moved inside the core holder 105. When the core holder 105, the switch 116, the holders 106a and 106b and the circuit board 104 be are configured to be secured in the pen cases 102a and 102b, the pen core 110, the ferrite core 112 and 108, the elastomer 109 and the touch pin 107 is configured to be restricted inside the space constituted by the pen case 102a and the core holder 105. A tape 120 is configured to be located on the holder 106b. A cap 122 is configured to be located on end of the holder 106b.

In one embodiment of the invention, since the space constituted by the pen case 102a and the core holder 105 is constant, the moving distance of the pen core 110 and the ferrite core 108 and the touch pin 107 is directly related to the compressibility of the elastomer 109. However, since the surface of one end of the core holder 105 has a thread which is able to be used to be screwed into the end of the holder 106b with a thread so as to be moved axially, the core holder 105 is able to be used to adjust the size of the space constituted by the pen case 102a and the core holder 105, or the moving distance of the pen core 110 and the ferrite core 108 and the touch pin 107, or the degree of compression of the elastomer 109.

In one embodiment of the invention, the conductive device 114 is configured to be located in the holders 106a and 106b and between the conductive terminals of the circuit board 104 and the end of the touch pin 107 extending out from the core holder 105. The conductive device 114 alters the status of contact with the conductive terminals of the circuit board 104 via the pushing of the end of the touch pin 107 extending out from the core holder 105 so as to connect the conductive terminals of the circuit board 104 and change the circuitry of the circuit board 104.

In one embodiment of the invention, the conductive device 114 comprises a cone spring or a conductive rubber, but is not limited to a cone spring or a conductive rubber. In one embodiment which the conductive device 114 is a cone spring, when one end of the touch pin 107 pushes the cone spring, the center of the cone spring will contacts the conductive terminals on one end of the circuit board 104 to electrically connect the conductive terminals and the change the circuitry of the circuit board 104. The electrically connection between the conductive terminals is able to be used to initiate the writing function of an electromagnetic pointer or a stylus, but is not limited to initiate the writing function.

In one embodiment of the invention, a conductive coil is configured to wind the ferrite core 112, the conductive coil is configured to be connected to the circuit of the circuit board 104. The conductive coil, the ferrite cores 112 and 108 constitute a variable inductor. The variable inductor is configured to be connected to the LC circuit of the circuit board 104. The inductance of the variable inductor is changed through the relative displacement between the ferrite cores 108, 112 and the conductive coil generated by the axial movement of the pen core 110 inside the ferrite core 112 with the winding conductive coil. In other word, the variation of the gap between the ferrite cores 108 and 112 changes the frequency of the LC circuit. The variation of the frequency is able to be used to change the line width of the trace of an electromagnetic pointer or a stylus, but is not limited to the line width of the trace.

In one embodiment of the invention, the switch 116 is configured to partially penetrate through the opening of the pen case 102a and to be located on the circuit board 104 as a switch of a circuit function thereof. The switch 116 is configured to be used as the switch of writing or erasing functions of the electromagnetic pointer or a stylus, but is not limited to writing or erasing functions.

It is noted that the embodiments of the invention focus on the configuration of the electromagnetic pointer rather than the function thereof. Thus the configuration of the embodiments of the invention is able to be applied any function of the electromagnetic pointer according to various requirements. The function which the configuration of the embodiments of the invention is applied to perform depends on circuit design.

In one embodiment of the invention, the elastomer 109 comprises, but is not limited to, rubber or other elastic material. When an electromagnetic pointer or a stylus are in use, a contact force is applied upon one end of the pen core 110 and is transferred to the other end of the pen core 110 to push the ferrite core 108 and change the gap between the ferrite cores 112 and 108. The ferrite core 108 compresses the elastomer 109 and pushes the touch pin 107. The touch pin 107 pushes the conductive device 114 to alter the contact status between the conductive terminals of the circuit board 104 and the conductive device 114 to initiate the function of the electromagnetic pointer such as the writing function.

When the electromagnetic pointer is not in use, there is a gap between the touch pin 107 and the conductive device 114, and the adjustment of the gap is performed through adjusting the core holder 105. As mentioned above, the core holder 105 is able to be used to adjust the size of the space constituted by the pen case 102a and the core holder 105, or the moving distance of the pen core 110 and the ferrite core 108 and the touch pin 107, or the degree of compression of the elastomer 109, or the length of the touch pin 107 extending out from the core holder 105, or the gap between the touch pin 107 and the conductive device 114.

Since the core holder 105 is included in the pen case 102a, the adjustment of the gap between the touch pin 107 and the conductive device 114 in the electromagnetic pointer or a stylus must be performed before the assembling of the electromagnetic pointer or the stylus is completed. The core holder 105 is configured to adjust the internal movable components so that the gap between the components induced from the tolerance or assembling is able to be adjusted to eliminate unnecessary error. The force needed to perform the writing function applied upon the electromagnetic pointer is able to be set by adjusting the degree of screwing tightness of the core holder 105.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An electromagnetic pointer, comprising:
a core;
a first ferrite core, a second ferrite core and a coil winding the first ferrite core, the core penetrating the first ferrite core, the second ferrite core accommodating a first end of the core;
a core holder, a surface of a first end of the core holder comprising a first thread, a first end of the first ferrite core, a first end of the core, the second ferrite core, an elastomer and a touch pin being configured in the core holder, the touch pin extending out from the first end of the core holder;
a holder, an inner surface of a first end of the holder comprising a second thread such that the core holder is able to be screwed in to the holder via the engaging between the first thread and the second thread; and
a circuit board, the circuit board being configured to be secured by the holder, one end of the circuit board comprising a plurality of conductive terminals, the conductive terminals adjacent the touch pin, a conductive device being between the conductive terminals and the touch pin, and the coil connecting to the circuit board.

2. The electromagnetic pointer of claim 1 further comprising a first case and a second case, the first case accommodating the core holder, the first ferrite core, the core, the second ferrite core, the elastomer, the touch pin, the conductive device, the holder and a portion of the circuit board.

3. The electromagnetic pointer of claim 2, wherein diameters of the first case and the second case are about 7.2 mm.

4. The electromagnetic pointer of claim 1, wherein the elastomer comprises rubber.

5. The electromagnetic pointer of claim 1, wherein the conductive device comprises a cone spring.

6. The electromagnetic pointer of claim 1, wherein the electromagnetic pointer is used with a smart mobile communication device, a digitizer or a tablet or an eBook.

7. The electromagnetic pointer of claim 2 further comprising a switch, the switch being configured to partially penetrate through an opening of the first case and to be located on the circuit board for switching a circuit function of the circuit board.

8. The electromagnetic pointer of claim 1 further comprising a buffer located between the first ferrite core and the second ferrite core.

9. An electromagnetic pointer, comprising:
a first case and a second case;
a core;
a first ferrite core, a second ferrite core and a coil winding the first ferrite core, the core penetrating the first ferrite core, the second ferrite core accommodating a first end of the core;
a core holder, a surface of a first end of the core holder comprising a first thread, a first end of the first ferrite core, a first end of the core, the second ferrite core, an elastomer and a touch pin being configured in the core holder, the touch pin extending out from the first end of the core holder;
a holder, an inner surface of a first end of the holder comprising a second thread such that the core holder is able to be screwed in to the holder via the engaging between the first thread and the second thread; and
a circuit board, the circuit board being configured to be secured by the holder, one end of the circuit board comprising a plurality of conductive terminals, the conductive terminals adjacent the touch pin, a conductive device being between the conductive terminals and the touch pin, and the coil connecting to the circuit board, the first case and the second case being combined.

10. The electromagnetic pointer of claim 9, wherein the conductive device comprises a cone spring.

11. The electromagnetic pointer of claim 9, wherein the electromagnetic pointer is used with a smart mobile communication device, a digitizer or a tablet or an eBook.

12. The electromagnetic pointer of claim 9 further comprising a switch, the switch being configured to partially penetrate through an opening of the first case and to be located on the circuit board for switching a circuit function of the circuit board.

13. The electromagnetic pointer of claim 9 further comprising a buffer located between the first ferrite core and the second ferrite core.
